(19) United States
(12) Patent Application Publication
(10) Pub. No.: US 2017/0297049 A1
(43) Pub. Date: Oct. 19, 2017

(54) APPLICATION DEVICE FOR MULTICOMPONENT MATERIALS

(71) Applicant: SIKA TECHNOLOGY AG, Baar (CH)

(72) Inventors: Manuel BUCK, Gebenstorf (CH); Andreas HUFSCHMID, Aarau (CH)

(73) Assignee: SIKA TECHNOLOGY AG, Baar (CH)

(21) Appl. No.: 15/513,438

(22) PCT Filed: Sep. 18, 2015
(86) PCT No.: PCT/EP2015/071512

§ 371 Date: Mar. 22, 2017

(30) Foreign Application Priority Data
Sep. 23, 2014 (EP) 14186035.3

(51) Int. Cl. B05C 17/005

(52) U.S. Cl. CPC B05C 17/00566; B05C 17/00586; B05C 17/00596

(57) ABSTRACT

The disclosure relates to an adapter piece for an application device for multicomponent materials, including multicomponent adhesives or multicomponent sealants. The application device has at least one first cartridge receiving device for receiving a first replaceable cartridge containing a first material component, at least one second cartridge receiving device for receiving a second replaceable cartridge containing a second material component, at least one discharging device for discharging the material components out of the cartridges through cartridge outlets, and at least one mixing device for mixing and discharging the material components. A second cartridge receiving area includes a relief chamber such that a material component exiting the second cartridge first fills the relief chamber before entering the mixing device.

### TECHNICAL FIELD

The invention relates to an application device for multicomponent materials, in particular multicomponent adhesives or multicomponent sealants.

### PRIOR ART

An application device of the generic type for multicomponent materials is described in EP 2 468 416 A1. The application device according to EP 2 468 416 A1 comprises an expulsion device for expelling material components from cartridges in predefined proportions with the aid of expulsion pistons, a mixing device, which mixes and discharges the expelled material components, and a cartridge lid, which is configured for the reception or attachment of the exchangeable mixing device. An adapter has a first receptacle for a first cartridge and a second receptacle for a second cartridge, wherein the first receptacle has an opening for an opening device of a tubular bag.

Standard cartridges have a sealing mechanism which must be opened prior to use, so that the material component can pass out of the cartridge. Such a sealing mechanism is regarded, however, as comparatively complex from a design aspect, and also in terms of its usage.

The object of the invention is therefore to demonstrate a (from a design and usage-related aspect) simplified way, in the use of an application device, of making a material component contained in the cartridge pass out of the corresponding cartridge.

### DISCLOSURE OF THE INVENTION

This object is achieved, in particular, by an adapter having the features of claim 1.

In particular, the object is achieved by an adapter for an application device for multicomponent materials, in particular multicomponent adhesives or multicomponent sealants, wherein the application device has at least a first cartridge receiving device for receiving a first exchangeable cartridge containing a first material component and at least a second cartridge receiving device for receiving a second exchangeable cartridge containing a second material component, at least one expulsion device for expelling the material components from the cartridges through cartridge outlets, a mixing device for mixing and discharging the material components, wherein the adapter has at least a first and at least a second cartridge receptacle, wherein the second cartridge receptacle has a relief volume such that a material component passing out of the second cartridge firstly fills the relief volume before passing into a mixing chamber via one or more mixing chamber inlets.

The application device, in particular its cartridge receiving devices, its expulsion device and/or its mixing device, can be configured as described in EP 2 468 416 A1. The adapter too can basically be configured as in EP 2 468 416 A1 (while allowing for the following differences or particularities).

The adapter in question is preferably a one-piece, in particular monolithic, element. For instance, the adapter can be produced from (just) one plastic, for example polymer, polyolefin, polyethylene, polypropylene or polyamide (etc.). Polypropylene is particularly preferred. The adapter basically constitutes a connecting adapter for connecting two (or more) cartridges (jointly) to the application device. For this, the adapter has in one specific embodiment at least one bushing for the first material component and at least one bushing for the second material component. In addition, the adapter can have a bushing for a drive shaft for the mixing device.

The relief volume (relief space) enables in a simple manner the use of cartridges with self-opening mechanism (for instance a lid element, in particular a lid film, which self-opens under pressure. When the pressure at the cartridge lid is appropriately high, the cartridge opens, so that the material component can flow out. A problem with this, however, is basically that the material component spurts into the mixing unit, resulting in incorrect dosages. In particular in multicomponent systems, it is extremely important, however, that the respective material components are supplied in a well metered manner in a predetermined proportions. In the event of incorrect dosages, numerous problems, such as too slow (or too fast) a hardening of the mixture, can arise. In this regard, it was also contemplated to open the cartridges through the use of a mounted mixing device (for example by puncturing). Such a solution was regarded, however, as offering comparatively little process reliability (for instance due to tilting of a puncturing tip or an excessive necessary length of the puncturing tip, etc.). As a result of the relief volume, however, the spurting of the material component is able to be prevented (or at least reduced). Thus, when the cartridge opens, the relief volume is firstly filled before the material component (then depressurized) flows into the mixing device. A regular flowing can thus be achieved. An incorrect dosage can successfully be prevented. The relief is thus preferably effected by a diversion via the relief volume.

The relief volume (relief brake) is constituted by a flow volume, which allows the material component to be metered in a controlled manner. To this end, the relief volume is dimensioned accordingly. Via the size of the relief volume, it is possible to set the delay with which the material component flowing into the relief volume joins up with the other material component in the mixing device.

The invention thus overcomes a prejudice implying that a self-opening mechanism (for instance via a bursting lid film) cannot function since spurting leads to problems, but also because the bursting open is regarded as not sufficiently process reliable. By virtue of the fact that the relief volume is firstly (fully) filled, a flow is relieved in a simple manner. As a result, comparatively simple self-opening mechanisms (for instance bursting films) can thus be provided without occurrence of the above-described problems (in particular too slow or too fast a hardening due to incorrect dosage).

The above-stated object is additionally achieved by an adapter for an application device for multicomponent materials, in particular multicomponent adhesives or multicomponent sealants, wherein the application device has at least a first cartridge receiving device for receiving a first exchangeable cartridge containing a first material component, at least a second cartridge receiving device for receiving a second exchangeable cartridge containing a second material component, at least one expulsion device for expelling the material components from the cartridges through cartridge outlets, as well as a mixing device for mixing and discharging the material components, wherein the adapter has at least a first and at least a second cartridge receptacle, wherein the second cartridge receptacle has a supporting device for supporting a closure part, in particular a closure film, of the second cartridge during rupturing of the closure part. As a result of such a supporting mechanism, a defined rupturing of the closure part is enabled, which increases the process reliability.

In one specific embodiment, the relief volume is configured at least in some sections (for example to the extent of at least 25% or at least 50% or at least 90% of a complete circle) as an annular space. As a result, a surge generated by the pressure shock can be reduced particularly effectively. In particular in combination with the above supporting device, it is synergistically achieved that the surge of the sealant component flows in a defined manner into the annular space and is relieved or reduced in this same. As a result, the material component is conducted particularly effectively such that it fills the relief volume before it can pass into the mixing device.

Preferably, the second cartridge receptacle has an inward pointing projection, on which the closure part, in particular the closure film, is preferably supported as it is ruptured. By an inward pointing projection should be understood a projection which projects in the direction of an inside of the adapter, in particular projects in the direction of the cartridge to be received. The projection can be of circular, elliptical or oval, or, indeed, polygonal configuration in cross section. In a three-dimensional perspective, the projection can be of cylindrical configuration. Preferably, the projection forms together with a (cylindrical) internal wall of the cartridge receptacle the annular space. Through such a structure, the projection can synergistically be used to support the closure part (the closure film) and, at the same time, as a limit structure for the relief volume (the annular space). As a result of the diversion via the relief volume (the annular space), the spurting of the material component is effectively prevented. The fact that the closure part (the closure film) opens at its margin ensures that the relief volume is always firstly filled before the material component flows into the mixing device. It is thereby ensured that the material component is relieved of pressure or flows regularly. An incorrect dosage can be effectively prevented.

The second cartridge receptacle, in particular the projection, preferably has at least one, preferably two openings, through which the second material component can flow as soon as the relief volume is filled. The openings can be connected to a discharge duct, which opens out into the mixing chamber (is preferably defined by an interior of the projection). The at least one opening can be disposed in a depression, so that, when a closure part (closure film) is in contact, a deaeration is enabled, and/or so that the opening is not fully closed off by the contacting closure part. The at least one opening can be disposed at a distal end of the projection (for instance on an end face). In any event, it is preferred that the at least one opening is disposed closer to the second cartridge (once this is mounted] than is a floor of the relief volume (for instance 2 mm or 4 mm closer). Through an (inwardly offset) opening, the material component, after a pressure relief or surge reduction, can flow into the mixing device in a well metered manner. All in all, a process reliable operation is enabled.

The projection can be cylindrically shaped and/or can be configured as a hollow body. In particular, an interior of the projection can form at least partially a fluid duct for conducting the material component in the direction of the mixing device. In such an embodiment, the projection can fulfill three functions at once, namely on the one hand a supporting function, on the other hand a function defining the relief volume, and thirdly a diverting function. A process reliable supplying of the material component is thus synergistically enabled by an, in design terms, extremely simple configuration.

In one specific embodiment, the at least one opening extends over an edge (in particular annular edge) of the projection. In general, the at least one opening can be disposed at least partially on an end face of the projection. Alternatively, it is also possible to dispose the at least one opening on a peripheral face (shell surface) of the projection. It should here definitely be ensured, however, that the relief volume is sufficiently dimensioned. In any event, a pressure relief or a reduction of the spurting is enabled in an, in design terms, simple and effective manner.

Preferably, a floor of the relief volume is of closed configuration (thus has no openings). Further preferably, that half of the relief volume which during use of the adapter is (farthest) remote from the associated cartridge is configured without openings. The openings are preferably provided in a half of the relief volume which (during use) closer to the associated cartridge. It is thereby effectively achieved that the relief volume firstly fills (without material components flowing off or onward), before the materials flow off or onward out of the openings.

In a general manner, the relief volume can be configured such that it firstly fills by a measure of at least 0.1 ml or at least 0.3 ml, or at least 30%, preferably by at least 60%, still further preferably by at least 80%, before the multicomponent material can leave the relief volume, i.e. flows onward. In this respect, the relief volume can (in a lower region) form a closed container. In addition, the relief volume can be configured such that a predetermined amount of the multicomponent material initially cannot flow onward, but rather the relief volume is firstly filled and only after this filling of the relief volume does the multicomponent material flow onward. The advantage consists in the fact that, over a certain period (preferably the period of spurting of the multicomponent material), this multicomponent material does not flow onward at all, but only once the multicomponent material is ejected from the cartridge at a comparatively low velocity. A high-velocity penetration of the multicomponent material into the mixer is thereby wholly avoided, or at least significantly reduced. In this respect, it is preferred that the velocity of the leading front of the multicomponent flow upon entry into the adapter device and until exit from the adapter device into the mixer is reduced by at least 30%, preferably at least 50%, still further preferably at least 70%.

In an alternative embodiment, the relief volume can be defined at least partially by a line extension. The line extension is here preferably dimensioned such that a surge which is present (due to constrictions or friction, etc.) is effectively reduced.

The supporting device preferably has an inward pointing projection (in particular that which is described above). Alternatively or additionally, the supporting device can be, at least in some sections, cylindrical, in particular hollow cylindrical, in shape and/or have a (round) end face.

In one specific embodiment, an end (in particular an end annular face) of the relief volume, which end faces away from the second cartridge, is fluid-tight (thus has no openings). Insofar as one (or more) opening(s) is/are provided, these are preferably arranged such that the material component only passes out of these same once it has been relieved by abutment against the end facing away from the second cartridge and by appropriate diversion or filling-up of the relief volume.

By an “adapter” should be understood, in particular, a separate element which is structurally distinct from the cartridges and the application device (if need be, is also configured so as to be detachable from the cartridges and/or the application device). It can also, however, be constituted by an integral element formed onto (attached to) the application device or the first and/or second cartridge.

The above-stated object is additionally achieved by an application system comprising an application device for multicomponent materials, in particular multicomponent adhesives or multicomponent sealants, wherein the application device has at least a first cartridge receiving device for receiving a first exchangeable cartridge containing a first material component and at least a second cartridge receiving device for receiving a second exchangeable cartridge containing a second material component, at least one expulsion device for expelling the material component from the cartridges through cartridge outlets, as well as a mixing device for mixing and discharging the material components, and an adapter of the type described above.

Preferably, the application system has at least a first and/or second cartridge. The first and/or second cartridge can be closed off by a closure part, in particular a closure film. The first cartridge can be formed from a tubular bag. The second cartridge can be configured from a self-supporting body (in particular cylinder). More specifically, first and/or second cartridge as described in EP 2 468 416 A1 can be formed.

According to the invention, a use of the adapter or of the application system for multicomponent materials (or their application), in particular multicomponent adhesives or multicomponent sealants, is also claimed. The multicomponent material (multicomponent adhesive or multicomponent sealant) preferably has a low viscosity (for example 1000 mPas or less, preferably 100 mPas or less, still further preferably 10 mPas or less). Specifically in the case such multicomponent materials, it proves particularly advantageous if a (due to the comparatively low viscosity) pronounced spurting is reduced.

In this respect, according to the invention, a method in which a multicomponent material, (multicomponent adhesive or multicomponent sealant), in particular having the above-stated viscosity values through the use of the adapter or the application system (as described above), is also claimed.

The first and/or second cartridge of the application system can be filled with a multicomponent material, in particular multicomponent adhesive or multicomponent sealant, preferably having the above viscosity values.

The multicomponent material (in particular multicomponent adhesive or multicomponent sealant) can preferably be formed on a base of polyurethane or acrylic or silicone, in general on a polymer base.

Ultimately, by virtue of the adapter or the application system, a delay to the expulsion of the second material component is achieved. A surge which is present, or a spurting, is reduced. The material component is made firstly to flow through the relief volume (or to fill this same) before it can pass out in the direction of the mixing device. In addition, a supporting function can be proposed, so that a closure part (closure film) does not tear in an undefined manner, with the result that defined outflow characteristics are realized. In one specific embodiment, a deaeration facility for the relief space can be formed.

### DESCRIPTION OF THE DRAWINGS

Advantages and expediency of the invention become clear from the following description of preferred illustrative embodiments on the basis of the figures, whereof:

FIG. 1 shows a schematically oblique view of an adapter;

FIG. 2 shows a side view of the adapter according to FIG. 1;

FIG. 3 shows the adapter according to FIG. 2 together with a mixing device and a first and second cartridge of a side view; and

FIG. 4 shows a detail of the adapter according to FIG. 1 in an oblique view.

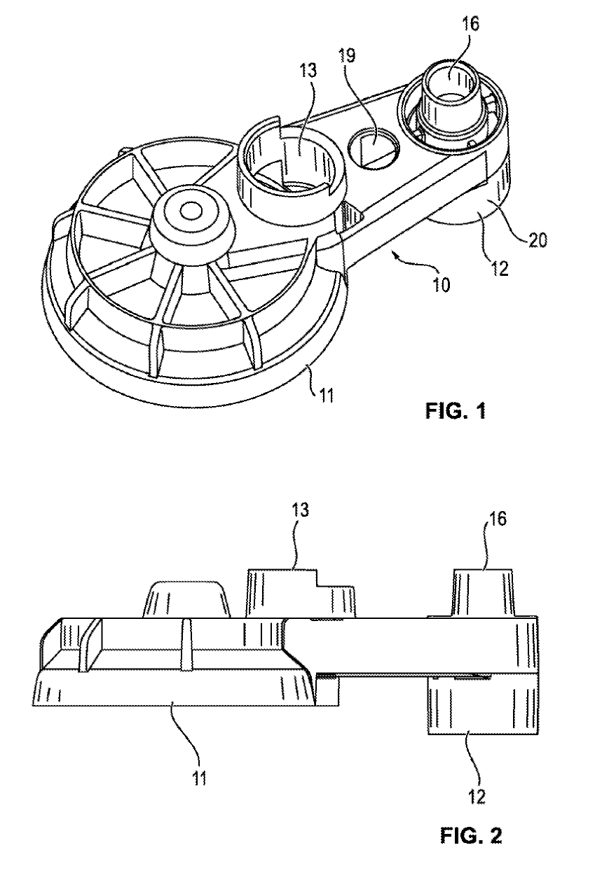

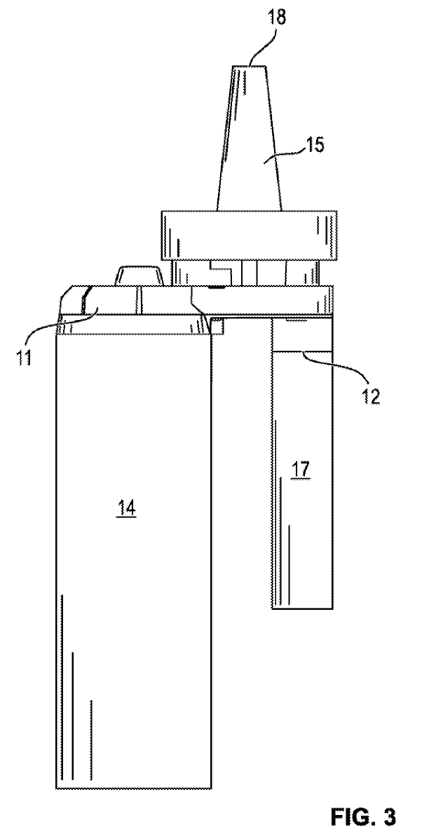

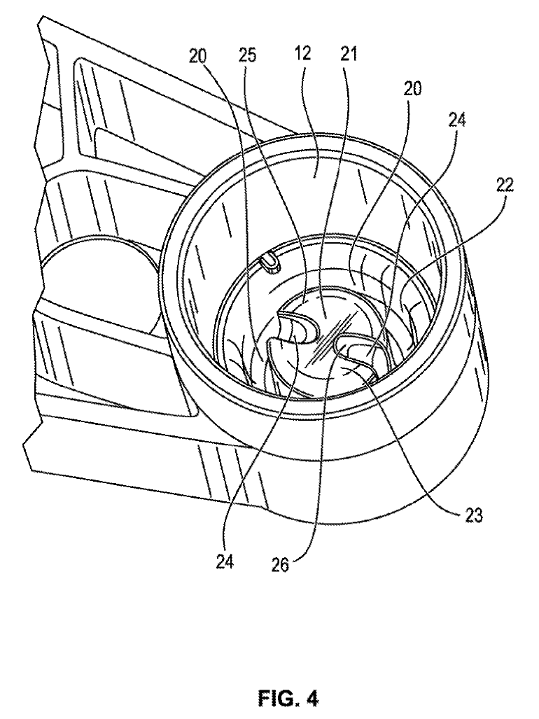

FIGS. 1 and 2 show an adapter 10 having a first cartridge receptacle 11 and a second cartridge receptacle 12. In addition, a first bushing 13 is provided to conduct a first material component from a first cartridge 14 (see FIG. 3) in the direction of a mixing device 15. Correspondingly, a second bushing 16 is provided to guide a second material component from a second cartridge 17 in the direction of the mixing device 15.

The mixing device 15 has a mixing device opening 18, from which the mixed material components can be applied.

In addition, the adapter 10 has a third bushing 19, through which a drive shaft (not shown) can be guided, so that the mixing device 15 can be driven.

The mixing device 15 is configured in detail, preferably as described in EP 2 468 416 A1. In addition, cartridge receiving devices, which can correspond to the cartridge receiving devices 2.1 and 2.2 according to EP 2 468 416 A1, can be provided.

A relief volume 20 is discernible in detail in FIG. 4. FIG. 4 corresponds to a detail from FIG. 1, with a view of the second cartridge receptacle 12. The relief volume 20 is specifically formed by a projection 21, which is directed inward, and a wall 22 of the second cartridge receptacle 12. The projection 21 is of (substantially) cylindrical and hollow configuration, so that an annular space is configured as a relief space 20. An end face 23 of the projection 21 is of circular configuration and has (at least in some sections) two openings 24, which extend over an annular edge 25 of the projection 21. Specifically, the openings 24 are configured in recesses 26, so that they are recessed. It is thereby enabled that a closure part of the second cartridge 17, when it bears against the end face 23 of the projection 21, does not close off the openings 26, so that, on the one hand, aeration can take place and, on the other hand, the material component can pass out of the openings 24.

If the cartridge 12 is inserted and its closure part (closure film) is subjected to pressure such that it tears, the design of the projection 21 leads the film to tear at the margin and the material component to pass into the relief volume 20, to fill this and, after the filling (which accompanies a corresponding relief), to be guided through the openings 24, so that it can make its way to the mixing device.

The projection 21 can have a height of at least 2 mm or at least 4 mm. The relief volume 20 can amount to at least 1 mm³ or at least 5 mm³ and/or at most 500 mm³ or 200 mm³. A depth of the relief volume preferably amounts to at least 2 mm or at least 4 mm.

### REFERENCE SYMBOL LIST

10 adapter
11 first cartridge receptacle
12 second cartridge receptacle
13 first bushing
14 first cartridge
15 mixing device
16 second bushing
17 second cartridge
18 mixing device opening
19 third bushing
20 relief volume
21 projection
22 wall
23 end face
24 opening
25 annular edge
26 recess

1. An adapter configured for an application device for multicomponent materials, including multicomponent adhesives or multicomponent sealants, wherein the application device has at least a first cartridge receiving device for receiving a first exchangeable cartridge containing a first material component, at least a second cartridge receiving device for receiving a second exchangeable cartridge containing a second material component, at least one expulsion device for expelling material components from the cartridges through cartridge outlets, and at least one mixing device for mixing and discharging the material components, wherein the adapter for such an application device comprises;
at least a first cartridge receptacle; and
at least a second cartridge receptacle, wherein the second cartridge receptacle includes a relief volume such that a material component when passed out of the second cartridge firstly will fill the relief volume before being passed into a mixing device.

2. An adapter as claimed in claim 1, for an application device for multicomponent materials, including multicomponent adhesives or multicomponent sealants, wherein the application device has at least a first cartridge receiving device for receiving a first exchangeable cartridge containing a first material component, at least a second cartridge receiving device for receiving a second exchangeable cartridge containing a second material component, at least one expulsion device for expelling material components from the cartridges through cartridge outlets, and at least one mixing device for mixing and discharging the material components, wherein the second cartridge receptacle comprises:
a supporting device for supporting a closure part configured as a closure film of the second cartridge during a rupturing of the closure part.

3. The adapter as claimed in claim 1, wherein the relief volume is configured at least in some sections as an annular space.

4. The adapter as claimed in claim 1, wherein the second cartridge receptacle has an inward pointing projection, on which the closure part, configured as the closure film, is supported as it is ruptured, wherein the projection, together with a cylindrical, inner wall of the second cartridge receptacle, defines the annular space.

5. The adapter as claimed in claim 4, wherein:
the second cartridge receptacle with the projection, has at least one opening through which the second material component will flow as soon as the relief volume is filled, wherein the opening is connected to a discharge duct, which is configured to open out into a mixing chamber and is defined by an interior of the projection and/or
wherein the opening is disposed in a depression, so that, when a closure part, configured as a closure film is in contact, a deaeration will be enabled, and/or the opening is not fully closed off by the contacting closure part configured as the adjacent closure film.

6. The adapter as claimed in claim 1, wherein the projection is cylindrically shaped and/or is configured as a hollow body.

7. The adapter as claimed in claim 5, wherein the opening extends over an annular edge, of the projection.

8. The adapter as claimed in claim 1, wherein the relief volume is defined at least partially by a line extension.

9. The adapter as claimed in claim 3, wherein the supporting device comprises:
an inward pointing projection and/or is, at least in some sections, hollow cylindrical in shape and/or has a round end face.

10. The adapter as claimed in claim 1, comprising:
an end annular face of the relief volume, which end faces away from the second cartridge, and is fluid-tight.

11. The adaptor of claim 1 in combination with an application system comprising;
an application device for multicomponent materials, including multicomponent adhesives or multicomponent sealants, wherein the application device includes:
at least a first cartridge receiving device for receiving a first exchangeable cartridge containing a first material component;
at least a second cartridge receiving device for receiving a second exchangeable cartridge containing a second material component;
at least one expulsion device for expelling the material components from the cartridges through cartridge outlets;
at least one mixing device for mixing and discharging the material components; and
an adapter according to claim 1.

12. The application system as claimed in claim 11, comprising;
at least a first and a second cartridge.

13. The application system as claimed in claim 12, wherein the first cartridge is formed from a tubular bag, and/or the second cartridge is formed from a self-supporting body, in particular a cylindrical body.

14. The application system as claimed in claim 11, wherein the first and/or second cartridge, in a preassembly state, is closed off by a rupturable closure element.

15. The application system as claimed in claim 12, wherein the first and/or second cartridge, in a preassembly state, is closed off by a rupturable closure element.

16. The application system as claimed in claim 12, wherein the first and/or second cartridge, in a preassembly state, is closed off by a rupturable closure film.
